(19) United States
(12) Patent Application Publication
(10) Pub. No.: US 2024/0159256 A1
(43) Pub. Date: May 16, 2024

(54) Systems and Methods for a Return Manifold

(71) Applicant: HUSCO International, Inc., Waukesha, WI (US)

(72) Inventors: Tom Peterson, New Berlin, WI (US); Andrew Kundert, Black River Falls, WI (US); Casey Buschkopf, Brookfield, WI (US)

(21) Appl. No.: 18/284,255

(22) PCT Filed: Mar. 25, 2022
(86) PCT No.: PCT/US2022/022013

§ 371 Date: Sep. 26, 2023

Related U.S. Application Data
(60) Provisional application No. 63/166,839, filed on Mar. 26, 2021.

(51) Int. Cl. F15B 21/04; E02F 9/22

(52) U.S. Cl. CPC F15B 21/04; E02F 9/2267; F15B 2201/405; F15B 2211/322; F15B 2211/41536; F15B 2211/45; F15B 2211/50554; F15B 2211/5154; F15B 2211/555; F15B 2211/7121

(57) ABSTRACT

A return manifold includes a housing having a first workport, a second workport, a third workport, and a fourth workport, and defining a first chamber and a second chamber. The return manifold includes a back-pressure disk arranged between the first workport and the first chamber, a bypass disk arranged between the first chamber and the second chamber, a back-pressure spring biased between the back-pressure disk and the bypass disk, and a bypass spring biased against the bypass disk. The back-pressure disk and the bypass disk are hydro-mechanically coupled so that movement of the bypass disk alters a force on the back-pressure disk and movement of the back-pressure disk alters a force on the bypass disk.

### CROSS-REFERENCES TO RELATED APPLICATIONS

The present application is based on and claims priority to U.S. Provisional Patent Application No. 63/166,839, filed on Mar. 26, 2021, which is incorporated herein by reference in its entirety.

### STATEMENT REGARDING FEDERALLY SPONSORED RESEARCH

Not Applicable.

### BACKGROUND

Off-highway machines/vehicles commonly include one or more functions that may be hydraulically controlled.

### BRIEF SUMMARY

The present disclosure provides systems and methods for a return manifold used to control pressure in a return line of a hydraulic system used in off-highway machines. The return manifold can include both a return back-pressure device and a bypass device. The return back-pressure device can restrict return flow from a main control valve (MCV). The bypass device can limit the pressure drop across a device downstream of the main control valve (e.g., a heat exchanger, a cooler, a filter, etc.) and allow flow to bypass the downstream device.

In one aspect, the present disclosure provides a return manifold for a hydraulic system. The hydraulic system includes a main control valve, a downstream restriction arranged downstream of the main control valve, and a tank. The return manifold includes a first workport arranged downstream of and in fluid communication with the main control valve, a second workport in fluid communication with an inlet-side of the downstream restriction, and a tank workport in fluid communication with the tank. The return manifold includes a back-pressure disk arranged between the first workport and the second workport, and a bypass disk movable to an open position where fluid flow is allowed to bypass the cooler and flow from the first workport to the tank workport. The back-pressure disk is movable between a closed position where fluid flow is inhibited between the first workport and the second workport and an open position where fluid communication is allowed between the first workport and the second workport. The return manifold further includes a back-pressure spring biased between the back-pressure disk and the bypass disk, and a bypass spring. The back-pressure spring generates a force on the bypass disk in a first direction and the bypass spring is biased against the bypass disk so that the bypass spring generates a force on the bypass disk in a second direction opposite to the first direction. The back-pressure spring and the bypass spring are arranged in series.

In one aspect, the present disclosure provides a return manifold for a hydraulic system. The hydraulic system includes a main control valve, a downstream restriction arranged downstream of the main control valve, and a tank. The return manifold includes a housing including a first workport, a second workport, and a tank workport. The housing defines a first chamber and a second chamber. The first workport is in fluid communication with the main control valve, the second workport is in fluid communication with an inlet-side of the downstream restriction, and the tank workport is in fluid communication with the tank. The return manifold further includes a back-pressure disk arranged between the first workport and the first chamber, a bypass disk arranged between the first chamber and the second chamber, a back-pressure spring biased between the back-pressure disk and the bypass disk, and a bypass spring biased against the bypass disk. The back-pressure disk and the bypass disk are hydro-mechanically coupled so that movement of the bypass disk alters a force on the back-pressure disk and movement of the back-pressure disk alters a force on the bypass disk.

In one aspect, the present disclosure provides a return manifold for a hydraulic system. The hydraulic system includes a main control valve, a downstream restriction arranged downstream of the main control valve, and a tank. The return manifold includes a housing having a first workport, a second workport, and a tank workport. The housing defining a first chamber and a second chamber. The first workport is in fluid communication with the main control valve, the second workport is in fluid communication with an inlet-side of the downstream restriction, and the tank workport is in fluid communication with the tank. The return manifold further includes a back-pressure valve arranged between the first workport and the first chamber, a bypass valve arranged between the first chamber and the second chamber, and a bypass spring biased against the bypass valve. The back-pressure valve and the bypass valve are hydro-mechanically coupled, so that a pressure drop between the first chamber and the second chamber has an effect on a position of both the back-pressure valve and the bypass valve.

The foregoing and other aspects and advantages of the disclosure will appear from the following description. In the description, reference is made to the accompanying drawings which form a part hereof, and in which there is shown by way of illustration a preferred configuration of the disclosure. Such configuration does not necessarily represent the full scope of the disclosure, however, and reference is made therefore to the claims and herein for interpreting the scope of the disclosure.

### BRIEF DESCRIPTION OF DRAWINGS

The invention will be better understood and features, aspects and advantages other than those set forth above will become apparent when consideration is given to the following detailed description thereof. Such detailed description makes reference to the following drawings.

FIG. 1 is a schematic illustration of a hydraulic system including a return manifold according to aspects of the present disclosure.

FIG. 2 is a sectional view of a return manifold according to aspects of the present disclosure.

FIG. 3 is a representation of the return manifold of FIG. 2 in a hydraulic circuit.

### DETAILED DESCRIPTION

Before any aspect of the present disclosure are explained in detail, it is to be understood that the present disclosure is not limited in its application to the details of construction and the arrangement of components set forth in the following description or illustrated in the following drawings. The present disclosure is capable of other configurations and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use aspects of the present disclosure. Various modifications to the illustrated configurations will be readily apparent to those skilled in the art, and the generic principles herein can be applied to other configurations and applications without departing from aspects of the present disclosure. Thus, aspects of the present disclosure are not intended to be limited to configurations shown, but are to be accorded the widest scope consistent with the principles and features disclosed herein. The following detailed description is to be read with reference to the figures, in which like elements in different figures have like reference numerals. The figures, which are not necessarily to scale, depict selected configurations and are not intended to limit the scope of the present disclosure. Skilled artisans will recognize the non-limiting examples provided herein have many useful alternatives and fall within the scope of the present disclosure.

The use of the terms “downstream” and “upstream” herein are terms that indicate direction relative to the flow of a fluid. The term “downstream” corresponds to the direction of fluid flow, while the term “upstream” refers to the direction opposite or against the direction of fluid flow.

A hydraulic system typically includes a device that adds restriction to a return circuit and is arranged downstream of a main control valve, e.g., a heat exchanger, an oil cooler, a filter, etc. Frequently, an oil cooler and/or a filter is provided in an oil return line. The return line may also include a bypass valve and a return back-pressure valve. The bypass valve opens when the pressure drop across the cooler and/or filter reaches a certain magnitude. This may be the result of high return flow or the oil cooler or filter being damaged/clogged and, thus, restricting or impeding flow. The return back-pressure valve maintains the return line pressure at an operating level to provide anti-void flow to hydraulic system functions.

In hydraulic systems, the return back-pressure valve is typically provided separately from the cooler and the cooler bypass valve (i.e., they are located at different locations along the return line or the valves that govern the back pressure and bypass functionality operate independently. This conventional arrangement requires more packaging space for two separate valves along the return line and reduces performance due to the separation between the return back-pressure valve and the cooler bypass valve.

Generally, the present disclosure provides a return manifold that incorporates bypass and return back pressure functionality in a device, where the operation of the return back pressure and bypass functionalities are hydro-mechanically coupled. Incorporating the bypass and return back pressure functionality into a single device improves packaging space and improves circuit performance, when compared to conventional hydraulic systems.

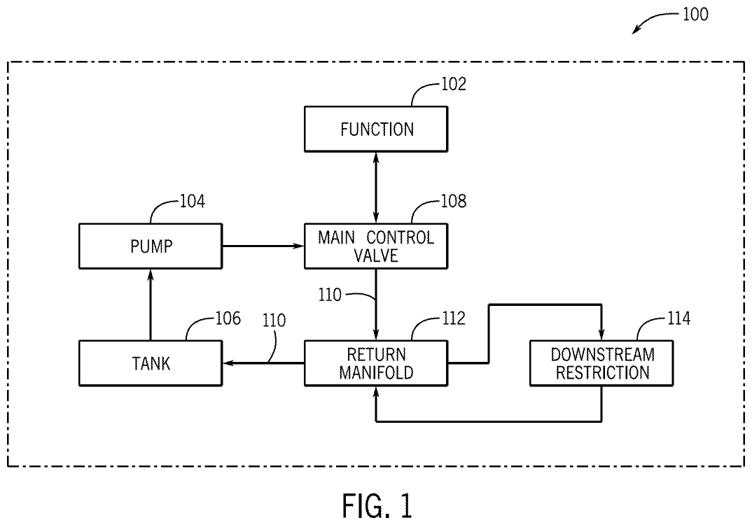

FIG. 1 illustrates a hydraulic system 100 that may control operation of one or more functions 102 on an off-highway machine/vehicle (e.g., an excavator, a backhoe loader, a dump truck, a bulldozer, etc.). The hydraulic system 100 includes a pump 104 that is configured to furnish a working fluid (e.g., oil) from a tank or reservoir 106 under increased pressure to a main control valve 108 arranged downstream of the pump 104. The main control valve 108 may include one or more spools, poppets, electrohydraulic valves, etc. that can control the flow of fluid to and from the function 102 to control operation of the function 102. The function 102 can be any component on an off-highway vehicle/machine that is hydraulically controlled (e.g., an actuator, a bucket, a motor, a mast, etc.). In the illustrated non-limiting example, the hydraulic system 100 includes a single main control valve 108 controlling fluid flow to the function 102, but other configurations are possible. For example, the main control valve 108 can control fluid flow to and from a plurality of functions, or a plurality of main control valves 108 can control fluid flow to and from a single function.

Downstream of the main control valve 108, a return line or conduit 110 provides fluid communication between the main control valve 108 and the tank 106. A return manifold 112 is arranged between the main control valve 108 and the tank 106 on the return line 110. That is, fluid flowing in a direction from the main control valve 108 toward the tank 106 passes through the return manifold 112. The return manifold 112 can allow at least a portion of the fluid flowing therethrough to flow through a downstream restriction 114 prior to returning to the tank 106. As will be described herein, the return manifold 112 is configured to ensure that a predefined amount of back pressure is maintained in the return line 110 upstream of the return manifold 112, and can selectively bypass the return flow so that it does not pass through the cooler 114 and instead is directed to directly to the tank 106. This configuration provides several advantages over conventional hydraulic systems that include two separated devices along a return line for the back pressure and bypass functionality. In some non-limiting examples, the downstream restriction 114 may be in the form of a heat exchanger, an oil cooler, a filter, or an equivalent structure configured to add restriction in a return conduit that requires bypassing.

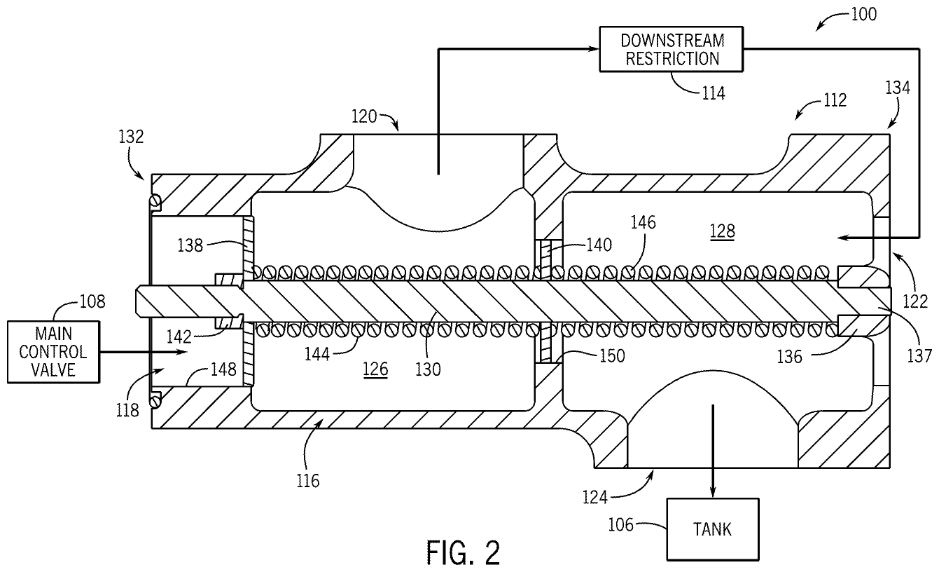

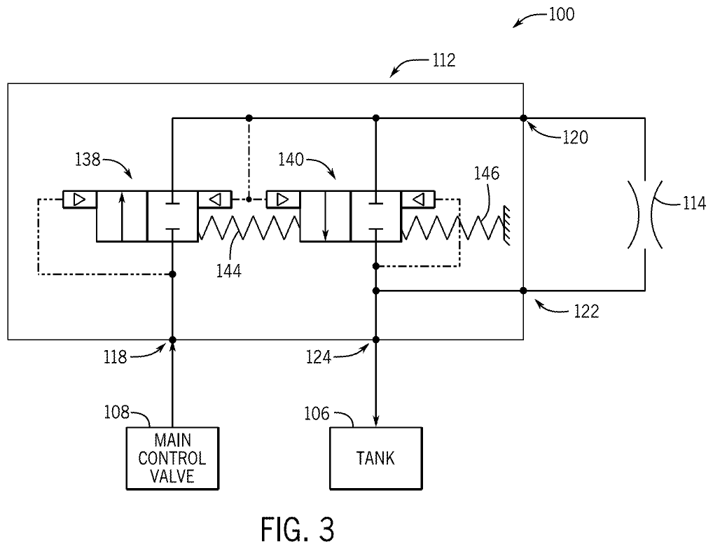

Turning to FIGS. 2 and 3, the return manifold 112 is illustrated in more detail. In the illustrated non-limiting example, the return manifold 112 includes a housing 116 having a first or inlet workport 118, a second or cooler inlet workport 120, a third or cooler outlet workport 122, and a fourth or tank workport 124. The housing 116 defines a first chamber or cavity 126 and a second chamber or cavity 128. The first chamber 126 and the second chamber 128 are arranged internally within the housing 116, with the first chamber 126 being arranged between the first workport 118 and the second workport 120 and the second chamber 128 being arranged between the third workport 122 and the fourth workport 124. In some non-limiting examples, the return manifold 112 may not include the third workport 122 and an outlet-side of the downstream restriction 114 may flow directly into the tank 106 without passing through the return manifold 112.

A retaining rod 130 extends internally through the housing 116. In the illustrated non-limiting example, the retaining rod 130 extends longitudinally through the housing 116 so that the retaining rod 130 extends through the first workport 118, the first chamber 126, and the second chamber 128. In other words, the retaining rod 130 extends from a first end 132 of the housing 116 to an opposing second end 134 of the housing 116. The retaining rod 130 can be secured to the housing 116 (e.g., prevented from displacing relative to the housing 116) by a threaded bore 136 of the housing 116. That is, the retaining rod 130 includes a threaded portion 137 that threads into the threaded bore 136 of the housing 116. In the illustrated non-limiting example, the threaded bore 136 is arranged at the second end 134 of the housing 116. In other non-limiting examples, the threaded bore 136 may be a through bore and a nut may be used to secure the retaining rod 130 to the housing 116.

The retaining rod 130 includes a back-pressure disk or valve 138 and a bypass disk or valve 140 arranged thereon. That is, the retaining rod 130 extends through the back-pressure disk 138 and the bypass disk 140 so that the back-pressure disk 138 and the bypass disk 140 can slide along an outer surface of the retaining rod 130. In the illustrated non-limiting example, the back-pressure disk 138 is arranged between the first workport 118 and the first chamber 126 and the bypass disk 140 is arranged between the first chamber 126 and the second chamber 128. In some embodiments, the back-pressure disk 138 and the bypass disk 140 may be in the form of poppets.

The back-pressure disk 138 is biased between a retaining nut 142 and a back-pressure spring 144. The back-pressure spring 144 encircles the retaining rod 130 and extends between the back-pressure disk 138 and the bypass disk 140. In other words, the back-pressure spring 144 is biased between and engages both the back-pressure disk 138 and the bypass disk 140. Because the back-pressure disk 138 is abutted against the retaining ring 142, the back-pressure spring 144 provides a biasing force on the bypass disk 140 in a direction away from the back-pressure disk 138 (e.g., to the right from the perspective of FIG. 2). The bypass disk 140 is biased between the back-pressure spring 144 and a bypass spring 146. The bypass spring 146 encircles the retaining rod 130 and extends between the bypass disk 140 and the retaining nut 136. In other words, the bypass spring 146 is biased between and engages both the bypass disk 140 and the retaining nut 136. Because the retaining nut 136 is rigidly attached to the retaining rod 130 (e.g., cannot move relative to the retaining rod) and the bypass spring 146 is abutted against the retaining nut 136, the bypass spring 146 provides a biasing force on the bypass disk in a direction toward the back-pressure disk 138 (e.g., to the left from the perspective of FIG. 2). That is, the back-pressure spring 144 provides a biasing force on the bypass disk 140 in a first direction and the bypass spring 146 provides a biasing force on the bypass disk 140 in a second direction, opposite to the first direction. In the illustrated non-limiting example, the back-pressure spring 144 is arranged in series with the bypass spring 146, which results in movement of one of the back-pressure disk 138 or the bypass disk 140 affecting the movement of the other. In this way, for example, the back-pressure disk 138 is hydro-mechanically coupled to the bypass disk 140 (i.e., the back-pressure spring 144 connects the back-pressure disk 138 and the bypass disk 140 and the pressure differential between the first chamber 126 and the second chamber 128 also influences the position of the bypass disk 140).

In general, the back-pressure spring 144 and the bypass spring 146 may be designed in various configurations. In the illustrated non-limiting example, the back-pressure spring 144 and the bypass spring 146 include similar designs with respect to number of coils, wire diameter, etc. But, in other non-limiting examples, the back-pressure spring 144 and the bypass spring 146 may be designed differently from one another (e.g., in one or more of spring rate, number of coils, wire diameter, free length, etc.). In some non-limiting examples, the back-pressure disk 138 and the bypass disk 140 may be connected with a spacer that provides a rigid mechanical coupling therebetween, rather than a spring.

In general, the back-pressure disk 138 is configured to restrict fluid flow from the first workport 118 into the first chamber 126 and the bypass disk 140 is configured to restrict fluid flow from the first chamber 126 into the second chamber 128. The balance of the forces resulting from the pressure drop across the back-pressure disk 138 and the back-pressure spring 144 govern the position of the back-pressure disk 138 along the retaining rod 130 (e.g., the amount of restriction between the first workport 118 and the first chamber 126). The balance of forces resulting from the pressure drop across the bypass disk 140, the back-pressure spring 144, and the bypass spring 146 govern the position of the bypass disk 140 along the retaining rod 130 (e.g., the amount of restriction between the first chamber 126 and the second chamber 128). In the illustrated non-limiting example, the back-pressure disk 138 defines a larger diameter than the bypass disk 140. In some non-limiting examples, the back-pressure disk 138 may define the same diameter as the bypass disk 140. In some non-limiting examples, the back-pressure disk 138 may define a smaller diameter than the bypass disk 140.

Operation of the return manifold 112 will be described with reference to FIGS. 1-3. In general, the return manifold 112 can maintain back pressure in the return line 110 upstream of the return manifold 112 and selectively bypass the downstream restriction 114. Return flow from the main control valve 108 is routed to the first workport 118. Initially, when the pressure acting on the back-pressure disk 138 is not great enough to generate a force on the back-pressure disk 138 that overcomes the force of the back-pressure spring 144, the back-pressure disk 138 is in a closed position where fluid flow is substantially inhibited from the first workport 118 into the first chamber 126. Specifically, in the closed position, the back-pressure disk 138 is arranged within a first bore 148 defined within the first workport 118. The back-pressure disk 138 will continue to substantially block fluid flow into the first chamber 126 until the pressure at the first workport 118 increases to a magnitude the generates a force on the back-pressure disk 138 that overcomes the force of the back-pressure spring 144 and displaces the back-pressure disk 138 (e.g., to the right from the perspective of FIG. 2) past the first bore 148 to an open position where fluid flows from the first workport 118 into the first chamber 126. In this way, for example, the back-pressure disk 138 and the back-pressure spring 144 maintain a predefined amount of back pressure in the return line 110 (i.e., the back-pressure disk 138 doesn't move to the open position until a predefined pressure is generated at the first workport 118).

As the back-pressure disk 138 moves toward the open position where fluid flow is allowed into the first chamber 126, the back-pressure spring 144 is compressed, which increases a force on the bypass disk 140 that urges the bypass disk 140 toward an open position where fluid flow is allowed between the first chamber 126 and the second chamber 128. This additional biasing force generated on the bypass disk 140, provided by the back-pressure disk 138 moving toward the open position, results from the series arrangement between the back-pressure spring 144 and the bypass spring 146 and the hydro-mechanical coupling between the back-pressure disk 138 and the bypass disk 140.

As the back-pressure disk 138 moves to the open position and fluid flow is allowed into the first chamber 126, fluid can flow out of the second workport 120 into an inlet-side of the downstream restriction 114, through the downstream restriction 114, from an outlet-side of the downstream restriction 114 to the third workport 122, and flow into the second chamber 128. As described herein, in some non-limiting examples, the outlet-side of the downstream restriction 114 may be directly connected to the tank 106 and the return manifold 112 may not include the third workport 122. The downstream restriction 114 defines a restriction in between the second workport 120 and the third workport 122 (see, e.g., FIG. 3), which results in the pressure in the first chamber 126 being higher than the pressure in the second chamber 128. The pressure drop between the first chamber 126 and the second chamber 128 (same as the pressure drop between the second workport 120 and the third workport 122) generates a force on the bypass disk 140 that urges the bypass disk 140 from a closed position toward an open position.

In the closed position, the bypass disk 140 is arranged within a bypass bore 150 defined between the first chamber 126 and the second chamber 128 within the housing 116 and fluid flow is substantially inhibited from the first chamber 126 into the second chamber 128. As the pressure drop between the first chamber 126 and the second chamber 128 increases, the bypass disk 140 is displaced along the bypass bore 150 and eventually displaces past the bypass bore 150 to an open position. In other words, the combined force of the pressure drop between the first chamber 126 and the second chamber 128 and the back-pressure spring 144 is balanced by the bypass spring 146, and as the pressure drop increases, the bypass spring 146 compresses and the bypass disk 140 moves toward the open position (e.g., to the right from the perspective of FIG. 2). In the open position, the bypass disk 140 allows fluid flow from the first chamber 126 into the second chamber 128. This allows at least a portion of the fluid flow to bypass the downstream restriction 114 and flow from the first workport 118 to the fourth workport 124 and on to the tank 106.

Due to the series arrangement between the back-pressure spring 144 and the bypass spring 146 and the hydro-mechanical coupling between the back-pressure disk 138 and the bypass disk 140, the increasing pressure drop that urges the bypass disk 140 toward the open position also urges the back-pressure disk 138 to open further. In general, the hydro-mechanical coupling between the back-pressure disk 138 and the bypass disk 140 results in movement of the back-pressure disk 138 altering the forces on the bypass disk 140 and vice versa. As described above, when the back-pressure disk 138 moves toward the open position, the force on the bypass disk 140 increases in a direction urging the bypass disk 140 toward an open position. Thus, the hydro-mechanical coupling also results in the pressure drop between the first chamber 126 and the second chamber 128 having an effect on a position of both the back-pressure disk 138 and the bypass disk 140. The combined flow from the from the third workport 122 and the bypass flow flowing from the first chamber 126 to the second chamber 128 is routed to the fourth workport 124 and on to the tank 106. As described herein, in some non-limiting examples, the flow returning from the downstream restriction 114 may flow directly to the tank 106, rather than into the third workport 122.

As described herein, the return manifold 112 provides the benefit of stacking the back-pressure spring 144 and the bypass spring 146 in series and hydro-mechanically coupling the back-pressure disk 138 and the bypass disk 140. Accordingly, the movement of one disk, e.g., the back-pressure disk 138, impacts the movement of the other disk, e.g., the bypass disk 140 and vice versa. This arrangement can improve the performance relative to a conventional back pressure device with a downstream bypass device. In addition, arranging the back-pressure disk 138, the bypass disk 140, the back-pressure spring 144, and the bypass spring 146 within a common housing 116 as a single device reduces packaging size and the installation footprint of the return manifold 112, reduces the number of components arranged downstream of the main control valve 108, and reduces costs.

Within this specification embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Thus, while the invention has been described in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein.

Various features and advantages of the invention are set forth in the following claims.

1. A return manifold for a hydraulic system, the hydraulic system including a main control valve, a downstream restriction arranged downstream of the main control valve, and a tank, the return manifold comprising:
a first workport arranged downstream of and in fluid communication with the main control valve, a second workport in fluid communication with an inlet-side of the downstream restriction, and a tank workport in fluid communication with the tank;
a back-pressure disk arranged between the first workport and the second workport, wherein the back-pressure disk is movable between a closed position where fluid flow is inhibited between the first workport and the second workport and an open position where fluid communication is allowed between the first workport and the second workport;
a bypass disk movable to an open position where fluid flow is allowed to flow from the first workport to the tank workport;
a back-pressure spring biased between the back-pressure disk and the bypass disk, wherein the back-pressure spring generates a force on the bypass disk in a first direction; and
a bypass spring biased against the bypass disk so that the bypass spring generates a force on the bypass disk in a second direction opposite to the first direction, wherein the back-pressure spring and the bypass spring are arranged in series.

2. (canceled)

3. The return manifold of claim 1, wherein the back-pressure disk is configured to move from the closed position to the open position when a pressure at the first workport generates a pressure force that overcomes a force generated by the back-pressure spring on the back-pressure disk.

4. The return manifold of claim 1, wherein the back-pressure disk, the bypass disk, the back-pressure spring, and the bypass spring are arranged within a housing; and
wherein the housing defines a first chamber and a second chamber, the first chamber being arranged between the first workport and the second workport, and the bypass disk being arranged between the first chamber and the second chamber.

5. The return manifold of claim 4, wherein the bypass disk is configured to move toward the open position as the pressure drop between the first chamber and the second chamber increases.

6. A return manifold for a hydraulic system, the hydraulic system including a main control valve, a downstream restriction arranged downstream of the main control valve, and a tank, the return manifold comprising:
a housing including a first workport, a second workport, and a tank workport, the housing defining a first chamber and a second chamber, wherein the first workport is in fluid communication with the main control valve, the second workport is in fluid communication with an inlet-side of the downstream restriction, and the tank workport is in fluid communication with the tank;
a back-pressure disk arranged between the first workport and the first chamber;
a bypass disk arranged between the first chamber and the second chamber;
a back-pressure spring biased between the back-pressure disk and the bypass disk; and
a bypass spring biased against the bypass disk, wherein the back-pressure disk and the bypass disk are hydro-mechanically coupled so that movement of the bypass disk alters a force on the back-pressure disk and movement of the back-pressure disk alters a force on the bypass disk.

7. The return manifold of claim 6, wherein the back-pressure disk is movable between a closed position where fluid flow is inhibited between the first workport and the second workport and an open position where fluid communication is allowed between the first workport and the second workport.

8. The return manifold of claim 6, wherein the bypass disk is movable to an open position where fluid flow is allowed between the first chamber and the second chamber.

9. The return manifold of claim 6, wherein the back-pressure spring generates a force on the bypass disk in a first direction.

10. The return manifold of claim 9, wherein the bypass spring generates a force on the bypass disk in a second direction opposite to the first direction.

11. The return manifold of claim 10, wherein the back-pressure spring and the bypass spring are arranged in series.

12. The return manifold of claim 6, wherein the back-pressure disk is configured to move from a closed position to an open position where fluid flow is provided between the first workport and the first chamber when a pressure at the first workport generates a pressure force that overcomes a force generated by the back-pressure spring on the back-pressure disk.

13. The return manifold of claim 6, wherein the bypass disk is configured to move toward an open position as the pressure drop between the first chamber and the second chamber increases.

14. The return manifold of claim 6, wherein the disks are configured as poppets.

15. A return manifold for a hydraulic system, the hydraulic system including a main control valve, a downstream restriction arranged downstream of the main control valve, and a tank, the return manifold comprising:
a housing including a first workport, a second workport, and a tank workport, the housing defining a first chamber and a second chamber, wherein the first workport is in fluid communication with the main control valve, the second workport is in fluid communication with an inlet-side of the downstream restriction, and the tank workport is in fluid communication with the tank;
a back-pressure valve arranged between the first workport and the first chamber;
a bypass valve arranged between the first chamber and the second chamber; and
a bypass spring biased against the bypass valve, wherein the back-pressure valve and the bypass valve are hydro-mechanically coupled, so that a pressure drop between the first chamber and the second chamber has an effect on a position of both the back-pressure valve and the bypass valve.

16. The return manifold of claim 15, further comprising a back-pressure spring biased between the back-pressure valve and the bypass valve.

17. The return manifold of claim 16, wherein the back-pressure valve is configured to move from a closed position to an open position where fluid flow is provided between the first workport and the first chamber when a pressure at the first workport generates a pressure force that overcomes a force generated by the back-pressure spring on the back-pressure valve.

18. The return manifold of claim 17, wherein the bypass valve is configured to move toward an open position as the pressure drop between the first chamber and the second chamber increases.

19. The return manifold of claim 16, wherein the back-pressure valve is movable between a closed position where fluid flow is inhibited between the first workport and the second workport and an open position where fluid communication is allowed between the first workport and the second workport.

20. The return manifold of claim 16, wherein the bypass valve is movable to an open position where at least one of:
fluid flow is allowed to bypass the downstream restriction and flow from the first workport to the tank workport; and
fluid flow is allowed from the first chamber to the second chamber.

21. (canceled)

22. The return manifold of claim 16, further comprising a back-pressure spring biased between the back-pressure valve and the bypass valve, wherein at least one of:
the back-pressure spring generates a force on the bypass valve in a first direction; and
the bypass spring generates a force on the bypass valve in a second direction.

23. (canceled)

24. (canceled)
